(19) United States
(12) Patent Application Publication
(10) Pub. No.: US 2020/0130598 A1
(43) Pub. Date: Apr. 30, 2020

(54) Ladder Rack

(71) Applicant: Kurt L. Kohl, Coon Rapids, MN (US)

(72) Inventor: Kurt L. Kohl, Coon Rapids, MN (US)

(21) Appl. No.: 16/665,372

(22) Filed: Oct. 28, 2019

Related U.S. Application Data
(60) Provisional application No. 62/851,806, filed on May 23, 2019.
(60) Provisional application No. 62/750,928, filed on Oct. 26, 2018.

(51) Int. Cl. B60R 9/042; B60R 9/048

(52) U.S. Cl. CPC B60R 9/0423; B60R 9/0485

(57) ABSTRACT

A ladder rack having a pair of side rails each having first and second ends, the pair of side rails connected by at least two cross bars. A pair of mounting brackets are connected to two of the cross bars, to attach the ladder rack to a roof rack, and a pair of ladder attachment devices are attached to two cross bars for attaching one or more ladders to the ladder rack.

### CROSS-REFERENCE TO RELATED APPLICATIONS

This Application claims the benefit of and priority to U.S. Provisional Application No. 62/750,928, filed Oct. 26, 2018, and also claims the benefit of and priority to U.S. Provisional Application No. 62/851,806, filed May 23, 2019, the entire contents of each of which are hereby incorporated by reference.

### STATEMENT REGARDING FEDERALLY SPONSORED RESEARCH

Not Applicable.

### BACKGROUND OF THE INVENTION

There is a need for an improved ladder rack, which is easy to attach to a vehicle and which can carry many different types of ladders.

Without limiting the scope of the invention a brief summary of some of the claimed embodiments of the invention is set forth below. Additional details of the summarized embodiments of the invention and/or additional embodiments of the invention may be found in the Detailed Description of the Invention, below.

A brief abstract of the technical disclosure in the specification is provided as well only for the purposes of complying with 37 C.F.R. 1.72. The abstract is not intended to be used for interpreting the scope of the claims.

### BRIEF SUMMARY OF THE INVENTION

The invention provides several embodiments of an improved ladder rack.

A first embodiment provides a ladder rack having a pair of side rails each having first and second ends, the pair of side rails connected by at least four cross bars. A pair of mounting brackets are connected to at least two of the four cross bars, to attach the ladder rack to a roof rack, and a pair of ladder attachment devices attached to at least two of the four cross bars for attaching one or more ladders to the ladder rack.

In one embodiment the side rails are parallel to each other, and in a second embodiment the cross bars are adjustable so the side rails are angled with respect to each other.

The adjustable cross bars can be made of two separate parts, for example one part could be 12 inches long and the other part could be 18 inches long, and the parts can be combined to vary the width of the cross bar.

The side bars contain a plurality of holes spaced along their length which allow for re-positioning of multiple cross bars to accommodate roof manufacturer racks of varying sizes.

The ladder assembly has “D” Rings and “U” bolts to secure ladder tie downs.

The ladder rack is sized so two ladder racks can fit side by side on the roof rack.

Another embodiment provides fixed or adjustable versions of a mini ladder rack having a pair of mounting brackets connected to each of a pair of cross bars, to attach the ladder rack to a roof rack, and a pair of ladder attachment devices attached to each of the cross bars for attaching one or more ladders to the ladder rack.

The cross bars can be of fixed width or adjustable width. The adjustable width cross bars can be made of two overlapping cross bar members which can be adjusted so that each cross bar can have a variable length. The adjustable cross bar members can range in length from 16.50 inches to 22.50 inches. The two overlapping cross bar members each have a slightly different width, so that one can slide inside the other. For example, one of the two overlapping cross bar members has a width of 6 inches and the other one of the two overlapping cross bar members has a width of 5.69 inches.

The ladder assembly has “D” Rings and “U” bolts to secure ladder tie downs. The ladder rack can be sized so that two ladder racks can fit side by side on the roof rack. Each cross bar includes tabs which hold a ladder on the mini ladder rack and prevent lateral movement of the ladder. A U-bolt can attach to each cross bar and can be used to prevent forward and rearward movement of a ladder.

### BRIEF DESCRIPTION OF THE DRAWINGS

FIG. 1 shows a perspective view of a first embodiment of the invention, an improved ladder rack configured for an extension ladder.

FIG. 2 shows a bottom view of the ladder rack of FIG. 1.

FIG. 3 shows a side view of the ladder rack of FIG. 1.

FIG. 4 shows a top view of the ladder rack of FIG. 1.

FIG. 5 shows a perspective view of a side rail.

FIG. 6 shows a side view of the side rail.

FIG. 7 shows bottom view of the side rail.

FIG. 8 shows top perspective view of a wide cross bar.

FIG. 9 shows a bottom view of the wide cross bar.

FIG. 10 shows a side view of the wide cross bar.

FIG. 11 shows an end view of the wide cross bar.

FIG. 12 shows top perspective view of a narrow cross bar.

FIG. 13 shows a bottom view of the narrow cross bar.

FIG. 14 shows a side view of the narrow cross bar.

FIG. 15 shows an end view of the narrow cross bar.

FIG. 16 shows top perspective view of a mounting bracket.

FIG. 17 shows a bottom view of the mounting bracket.

FIG. 18 shows a side view of the mounting bracket.

FIG. 19 shows an end view of the mounting bracket.

FIG. 20 shows a perspective view of a second embodiment of the invention, an adjustable width ladder rack configured for an extension ladder, a step ladder, or a multi-positional ladder.

FIG. 21 shows a view of the ladder rack of FIG. 20 in a first width.

FIG. 22 shows a view of the ladder rack of FIG. 20 in a second wider width.

FIG. 23 shows a top view of the ladder rack of FIG. 20.

FIG. 24 shows a side view of the ladder rack of FIG. 20.

FIG. 25 shows a bottom view of the ladder rack of FIG. 20.

FIG. 26 shows a perspective view of a side rail.

FIG. 27 shows a side view of the side rail.

FIG. 28 shows a bottom view of the side rail.

FIG. 29 shows an end view of the side rail.

FIG. 30 shows a top perspective view of an outer part of a wide cross bar.

FIG. 31 shows a bottom view of the outer part.

FIG. 32 shows a side view of the outer part.

FIG. 33 shows an end view of the outer part.

FIG. 34 shows a top perspective view of an outer part of a narrow cross bar.

FIG. 35 shows a bottom view of the outer part.

FIG. 36 shows a side view of the outer part.

FIG. 37 shows an end view of the outer part.

FIG. 38 shows a top perspective view of a mounting bracket.

FIG. 39 shows a bottom view of the mounting bracket.

FIG. 40 shows a side view of the mounting bracket.

FIG. 41 shows an end view of the mounting bracket.

FIG. 42 shows a top perspective view of an alternative embodiment of an outer part of a narrow cross bar.

FIG. 43 shows a bottom view of the outer part.

FIG. 44 shows a side view of the outer part.

FIG. 45 shows an end view of the outer part.

FIG. 46 shows a top perspective view of an embodiment of an inner part of a narrow cross bar.

FIG. 47 shows a bottom view of the inner part.

FIG. 48 shows a side view of the inner part.

FIG. 49 shows an end view of the inner part.

FIG. 50 shows a top perspective view of an alternative embodiment of an inner part of a narrow cross bar.

FIG. 51 shows a bottom view of the inner part.

FIG. 52 shows a side view of the inner part.

FIG. 53 shows an end view of the inner part.

FIG. 54 shows a top perspective view of an inner part of a wide cross bar.

FIG. 55 shows a bottom view of the inner part.

FIG. 56 shows a side view of the inner part.

FIG. 57 shows an end view of the inner part.

FIG. 58 shows a top perspective view of an alternative embodiment inner part of an end cross bar.

FIG. 59 shows a bottom view of the inner part.

FIG. 60 shows a side view of the inner part.

FIG. 61 shows an end view of the inner part.

FIG. 62 shows a top perspective view of an alternative embodiment outer part of a wide cross bar.

FIG. 63 shows a bottom view of the outer part.

FIG. 64 shows a side view of the outer part.

FIG. 65 shows an end view of the outer part.

FIG. 66 shows a perspective view of a third embodiment of the invention, an adjustable width ladder rack configured for an extension ladder, a step ladder or a multi-positional ladder

FIG. 67 shows a view of the ladder rack of FIG. 66 in a first width.

FIG. 68 shows a view of the ladder rack of FIG. 66 in a second wider width.

FIG. 69 shows a top view of the ladder rack of FIG. 66.

FIG. 70 shows a side view of the ladder rack of FIG. 66.

FIG. 71 shows a bottom view of the ladder rack of FIG. 66.

FIG. 72 shows a perspective view of a side rail.

FIG. 73 shows a side view of the side rail.

FIG. 74 shows an end view of the side rail.

FIG. 75 shows a bottom view of the side rail.

FIG. 76 shows a top perspective view of an outer part of a wide cross bar.

FIG. 77 shows a bottom view of the outer part.

FIG. 78 shows a side view of the outer part.

FIG. 79 shows an end view of the outer part.

FIG. 80 shows a top perspective view of an outer part of a narrow cross bar.

FIG. 81 shows a bottom view of the outer part.

FIG. 82 shows a side view of the outer part.

FIG. 83 shows an end view of the outer part.

FIG. 84 shows a top perspective view of a mounting bracket.

FIG. 85 shows a bottom view of the mounting bracket.

FIG. 86 shows a side view of the mounting bracket.

FIG. 87 shows an end view of the mounting bracket.

FIG. 88 shows a top perspective view of an alternative embodiment of an inner part of a narrow cross bar.

FIG. 89 shows a bottom view of the inner part.

FIG. 90 shows a side view of the inner part.

FIG. 91 shows an end view of the inner part.

FIG. 92 shows a top perspective view of an embodiment of an inner part of a narrow cross bar.

FIG. 93 shows a bottom view of the inner part.

FIG. 94 shows a side view of the inner part.

FIG. 95 shows an end view of the inner part.

FIG. 96 shows a top perspective view of an alternative embodiment of an inner part of a narrow cross bar.

FIG. 97 shows a bottom view of the inner part.

FIG. 98 shows a side view of the inner part.

FIG. 99 shows an end view of the inner part.

FIG. 100 shows a top perspective view of an outer part of a wide cross bar.

FIG. 101 shows a bottom view of the outer part.

FIG. 102 shows a side view of the outer part.

FIG. 103 shows an end view of the outer part.

FIG. 104 shows a bottom perspective view of one of a pair of a fourth embodiment of the invention, a mini ladder rack.

FIG. 105 shows the other of the pair.

FIG. 106 shows a bottom view of FIG. 104.

FIG. 107 shows the bottom view of FIG. 105.

FIG. 108 shows a side view of FIG. 104.

FIG. 109 shows a side view of FIG. 105.

FIG. 110 shows an end view of the fourth embodiment.

FIG. 111 shows a top view of FIG. 104.

FIG. 112 shows a top view of FIG. 105.

FIG. 113 shows a side view of FIG. 104.

FIG. 114 shows a side view of FIG. 105.

FIG. 115 shows a bottom view of FIG. 104.

FIG. 116 shows a bottom view of FIG. 105.

FIG. 117 shows a top perspective view of a bracket.

FIG. 118 shows a bottom view of the bracket.

FIG. 119 shows a side view of the bracket.

FIG. 120 shows an end view of the bracket.

FIG. 121 shows a top perspective view of one of the pair of the fourth embodiment.

FIG. 122 shows FIG. 121 before the sides are bent up and the channel flanges are bent down.

FIG. 123 shows a side view of FIG. 121.

FIG. 124 shows a bottom view of FIG. 121.

FIG. 125 shows an end view of FIG. 121.

FIG. 126 shows the bottom and side of the fourth embodiment prior to being attached to a vehicle.

FIG. 127 shows the top of a pair of the fourth embodiment, with the U bolt attached.

FIG. 128 shows a top view of one of the pair of the fourth embodiment, and a side view of the other of the pair.

FIG. 129 shows a top view of one of the pair of the fourth embodiment, and a bottom view of the other of the pair.

FIG. 130 shows a bottom perspective view of one of a pair of a fifth embodiment of the invention, an adjustable mini ladder rack.

FIG. 131 shows the other of the pair.

FIG. 132 shows an side view of FIG. 130.

FIG. 133 shows a side view of FIG. 131.

FIG. 134 shows a bottom view of FIG. 130.

FIG. 135 shows the bottom view of FIG. 131.

FIG. 136 shows a front view of the fifth embodiment in a first width.

FIG. 137 shows a front view of the fifth embodiment in a second wider width.

FIG. 138 shows a top view at the first width.

FIG. 139 shows a top view at the wider width.

FIG. 140 shows a side view of FIG. 130.

FIG. 141 shows a side view of FIG. 131.

FIG. 142 shows a bottom view of FIG. 130.

FIG. 143 shows a bottom view of FIG. 131.

FIG. 144 shows a top perspective view of a mounting bracket.

FIG. 145 shows a bottom view of the mounting bracket.

FIG. 146 shows a side view of the mounting bracket.

FIG. 147 shows an end view of the mounting bracket.

FIG. 148 shows a top perspective view of an outer part of the pair of the fifth embodiment.

FIG. 149 shows FIG. 148 before the side is bent up and the channel flanges are bent down.

FIG. 149a shows a side view of FIG. 148.

FIG. 150 shows an end view of FIG. 148.

FIG. 151 shows a top perspective view of an inner part of the pair of the fifth embodiment.

FIG. 152 shows FIG. 151 before the side is bent up and the channel flanges are bent down.

FIG. 153 shows a side view of FIG. 151.

FIG. 154 shows an end view of FIG. 151.

FIG. 155 shows a top perspective view of an alternative inner part of the pair of the fifth embodiment.

FIG. 156 shows FIG. 155 before the side is bent up and the channel flanges are bent down.

FIG. 157 shows a side view of FIG. 155.

FIG. 158 shows an end view of FIG. 155.

FIG. 159 shows a top perspective view of an alternative outer part of the pair of the fifth embodiment.

FIG. 160 shows FIG. 159 before the side is bent up and the channel flanges are bent down.

FIG. 161 shows a side view of FIG. 159.

FIG. 162 shows an end view of FIG. 159.

FIG. 163 shows the bottom of the fifth embodiment prior to being attached to a vehicle.

FIG. 164 shows the top of a pair of the fifth embodiment, with the U bolt attached.

FIG. 165 shows a top view of one of the pair of the fifth embodiment, and a side view of the other of the pair.

FIG. 166 shows a top view of one of the pair of the fifth embodiment, and a bottom view of the other of the pair.

### DETAILED DESCRIPTION OF THE INVENTION

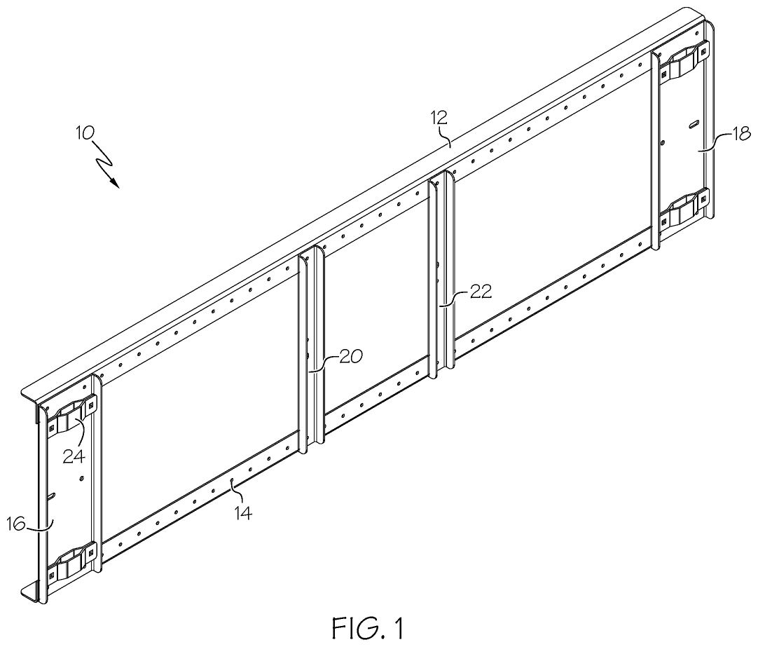

Referring now to FIG. 1, a perspective view of a first embodiment fixed width improved ladder rack for carrying extension ladders is shown generally at 10. The ladder rack has a pair of side rails 12 and 14, which are connected with front and back crossbars 16 and 18 and a narrow pair of crossbars 20 and 22. The ladder rack is attached to a vehicle using two pairs of clamps 24 (also referred to as mounting brackets), two on each of the front and back crossbars 16 and 18. The clamps or mounting brackets 24 are sized to be attachable to a roof rack crossbar of a vehicle.

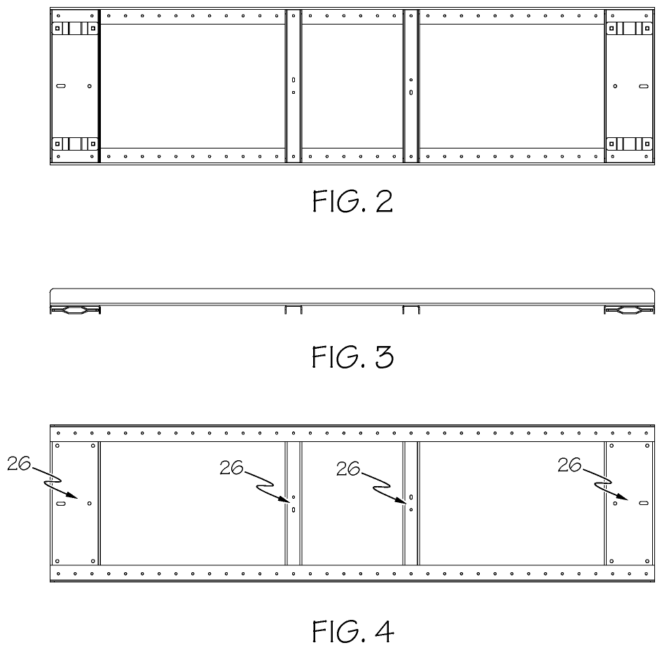

Referring now to FIGS. 2-4, a bottom view, side view and top view of the ladder rack of FIG. 1 is shown. FIG. 4 also shows attachment holes 26 in each crossbar, which can be used to attach “D” Rings and “U” bolts to secure a ladder with tie downs.

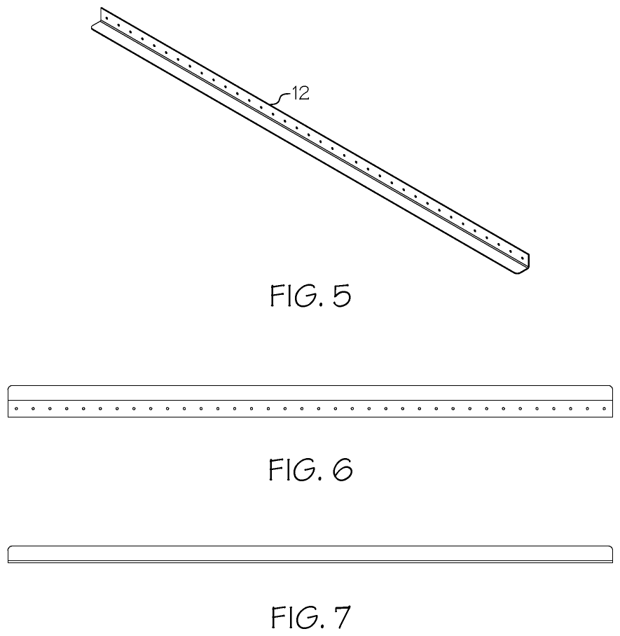

FIG. 5 shows a perspective view of a side rail.

FIG. 6 shows a side view of the side rail.

FIG. 7 shows bottom view of the side rail.

FIG. 8 shows top perspective view of a wide cross bar.

FIG. 9 shows a bottom view of the wide cross bar.

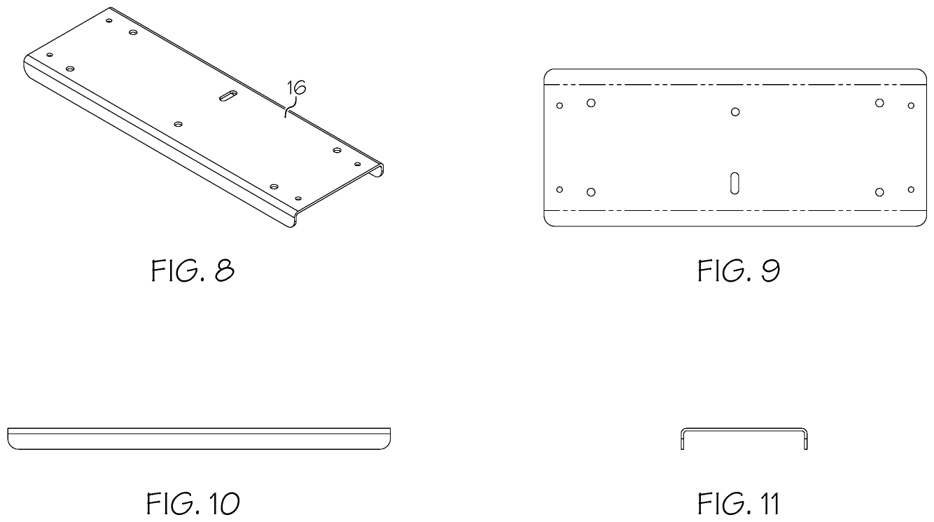

FIG. 10 shows a side view of the wide cross bar.

FIG. 11 shows an end view of the end cross bar.

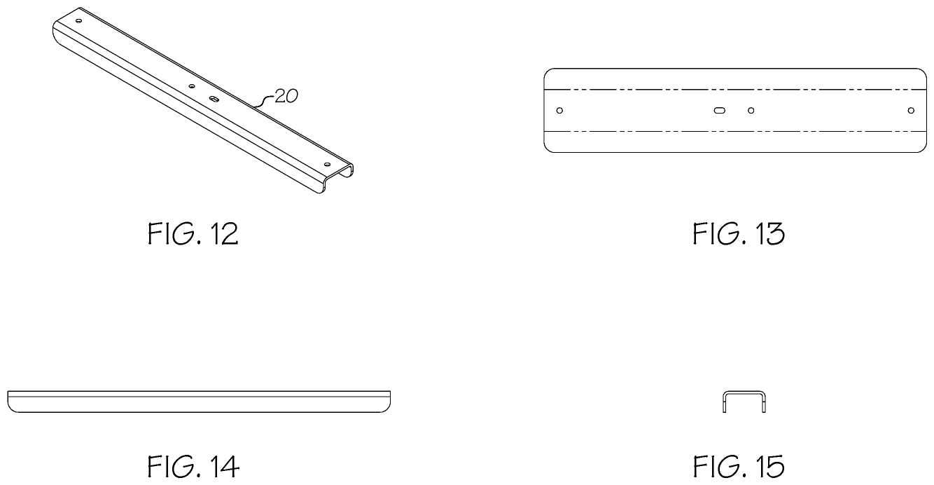

FIG. 12 shows top perspective view of an narrow cross bar.

FIG. 13 shows a bottom view of the narrow cross bar.

FIG. 14 shows a side view of the narrow cross bar.

FIG. 15 shows an end view of the narrow cross bar.

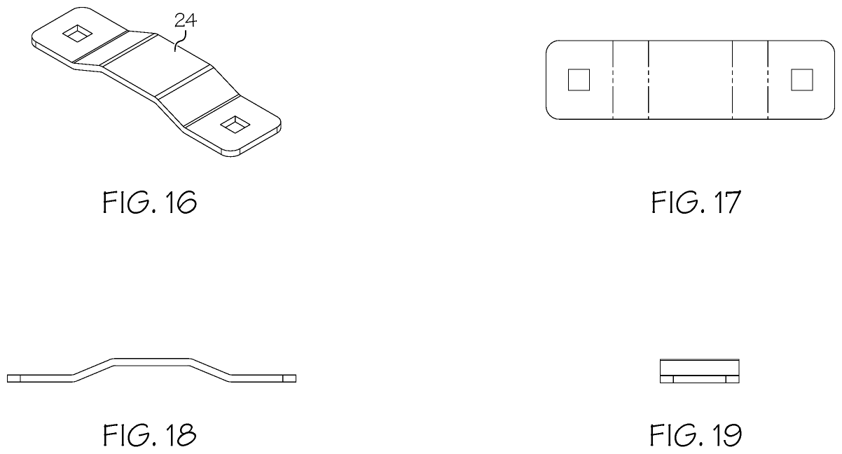

FIG. 16 shows top perspective view of a mounting bracket.

FIG. 17 shows a bottom view of the mounting bracket.

FIG. 18 shows a side view of the mounting bracket.

FIG. 19 shows an end view of the mounting bracket.

The ladder rack 10 is designed to be mounted to a vehicle with a manufacturer roof rack with cross bars or on an after-market roof rack with cross bars. The side rails 12 and 14 have paired holes evenly spaced along length of side rail for attachment of cross bars. The wide cross bars 16 and 18 are wider than the narrow cross bars 20 and 22. Cross bars 16 and 18 have pre-cut holes for mounting the cross bar to the rails 12 and 14. There are also pre-cut holes for attachment of ‘U’-bolts and pre-cut holes for attachment of mounting brackets 24 to the bottom of the cross bars. The narrower cross bars 20 and 22 have pre-cut holes for attachment to the side rails 12 and 14 and pre-cut holes for attachment of ‘D’-rings (not shown). In one embodiment, two ‘D’-rings attached one each to the top side of the narrow cross bars 20 and 22 to attach tie-down straps. Two ‘U’-bolts are attached one each to the top side of the wide cross bars 16 and 18 to attach tie-downs and control forward and backward movement of the ladder on the ladder rack.

Four mounting brackets 24 are attached two each to the bottom of the wide cross bars 16 and 18 to attach the ladder rack to a manufacturer or after-market roof rack on a vehicle. Each bracket 24 is comprised of arched stainless steel with pre-cut square holes on the ends of the bracket to receive the square shank of a carriage bolt for assembly. A nylon spacer allows adjustment of the bracket to accommodate vehicle roof racks with cross bars of varying size. Each bracket is attached using a pair of carriage bolts with lock nuts to attach mounting brackets to ladder rack. Foam tape on inside of brackets cushions brackets from vehicle cross bars.

The ladder rack side rails 12 and 14 and cross bars 16, 18, 20 and 22 are custom laser cut with radius corners and bends for appearance, strength and safety. The Cross bars can be assembled in different configurations to fit different style and size vehicles with roof racks—for example:
Wide, Narrow, Narrow, Wide (typical of large SUV with rear lift gate);
Wide, Narrow, Wide, Narrow (typical of small to mid-size SUV with rear lift gate) or
Narrow, Wide, Wide, Narrow (typical of passenger vehicle with rear trunk).

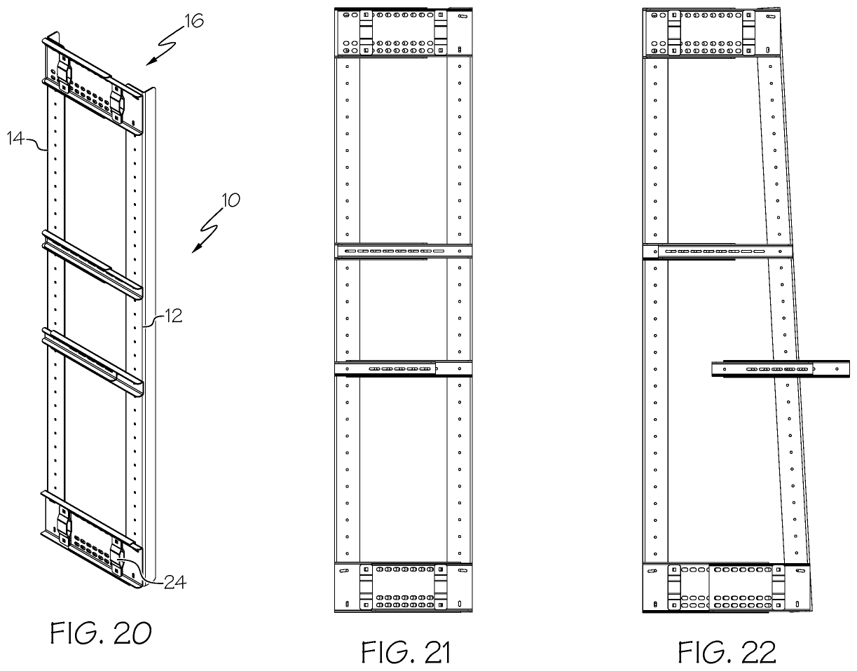

Referring now to FIG. 20, a perspective view of a second embodiment adjustable width ladder rack for carrying extension ladders, step ladders or multi-positional ladders, is shown generally at 10. The ladder rack has a pair of side rails 12 and 14, which are connected with front and back crossbars 16 and 18 and a narrow pair of crossbars 20 and 22. In this embodiment, each cross bar is comprised of two pieces which can be attached together to form cross bars of varying widths. For example, crossbar 16 is comprised of a 12″ outer section 28 and a 16″ inner section 30. The ladder rack is attached to a vehicle using two pairs of clamps (mounting brackets) 24, two on each of the front and back crossbars 16 and 18. The clamps 24 are sized to be attachable to a roof rack crossbar of a vehicle.

FIG. 21 shows a view of the ladder rack of FIG. 20 in a first width.

FIG. 22 shows a view of the ladder rack of FIG. 20 in a second wider width.

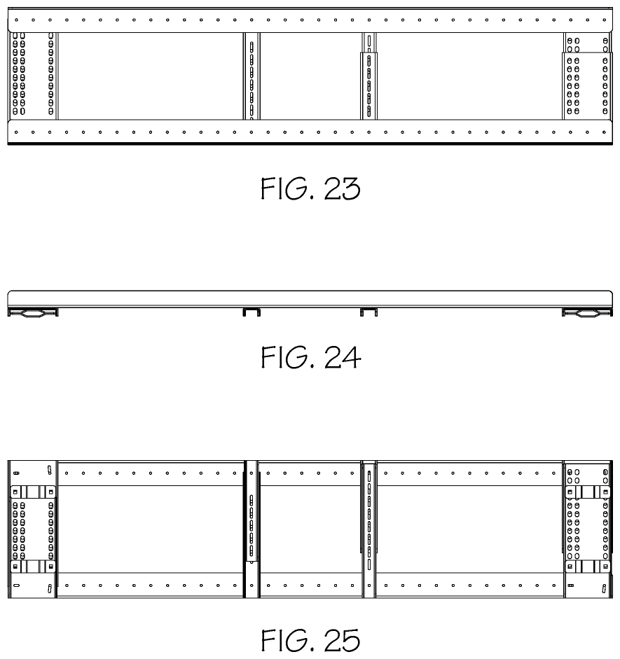

FIG. 23 shows a top view of the ladder rack of FIG. 20.

FIG. 24 shows a side view of the ladder rack of FIG. 20.

FIG. 25 shows a bottom view of the ladder rack of FIG. 20.

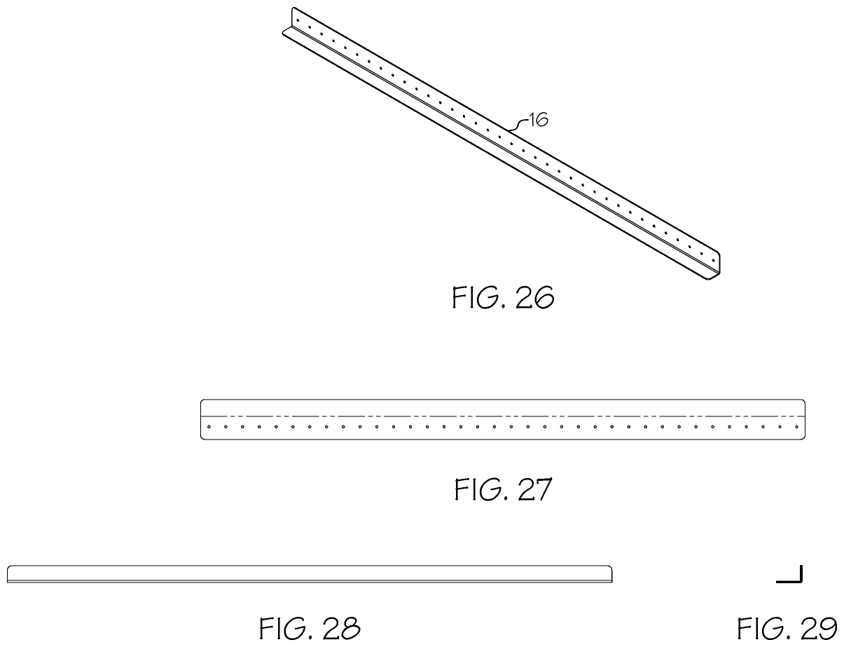

FIG. 26 shows a perspective view of a side rail.

FIG. 27 shows a side view of the side rail.

FIG. 28 shows a bottom view of the side rail.

FIG. 29 shows an end view of the side rail.

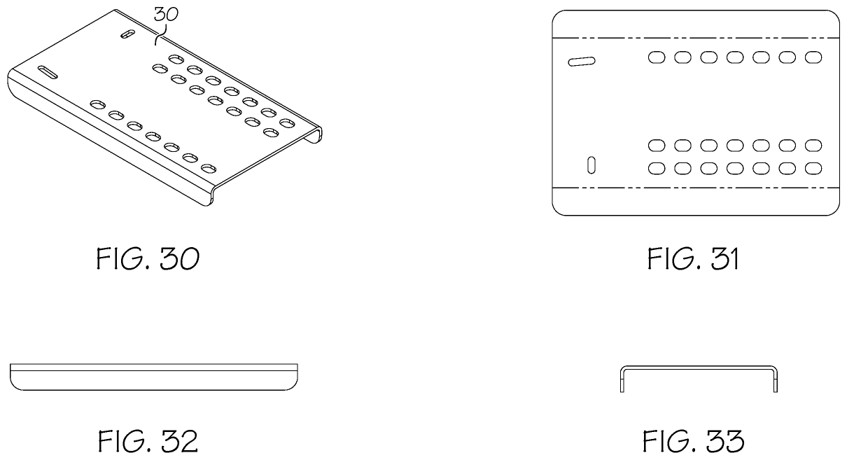

FIG. 30 shows a top perspective view of an outer part of a wide cross bar.

FIG. 31 shows a bottom view of the outer part.

FIG. 32 shows a side view of the outer part.

FIG. 33 shows an end view of the outer part.

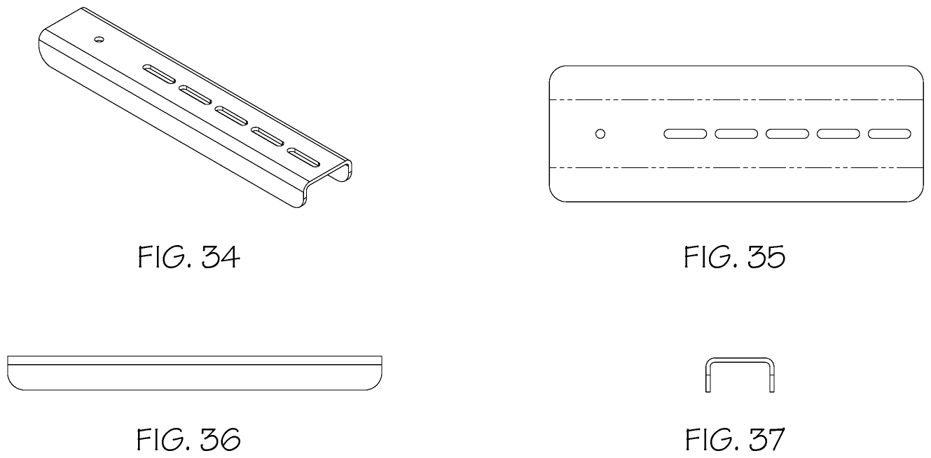

FIG. 34 shows a top perspective view of an outer part of a narrow cross bar.

FIG. 35 shows a bottom view of the outer part.

FIG. 36 shows a side view of the outer part.

FIG. 37 shows an end view of the outer part.

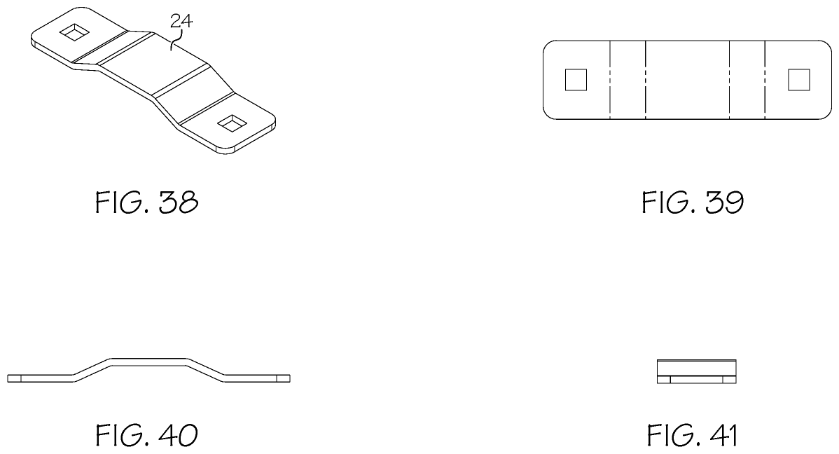

FIG. 38 shows a top perspective view of a mounting bracket.

FIG. 39 shows a bottom view of the mounting bracket.

FIG. 40 shows a side view of the mounting bracket.

FIG. 41 shows an end view of the mounting bracket.

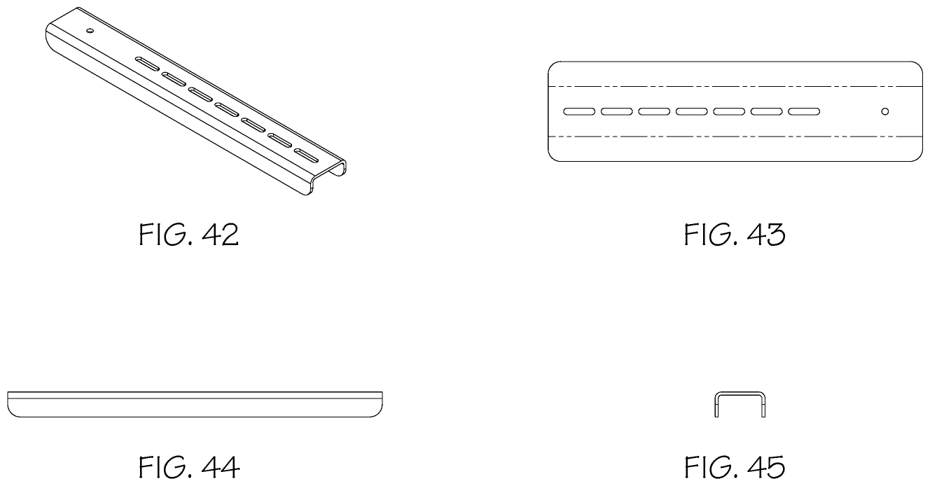

FIG. 42 shows a top perspective view of an alternative embodiment of an outer part of a narrow cross bar.

FIG. 43 shows a bottom view of the outer part.

FIG. 44 shows a side view of the outer part.

FIG. 45 shows an end view of the outer part.

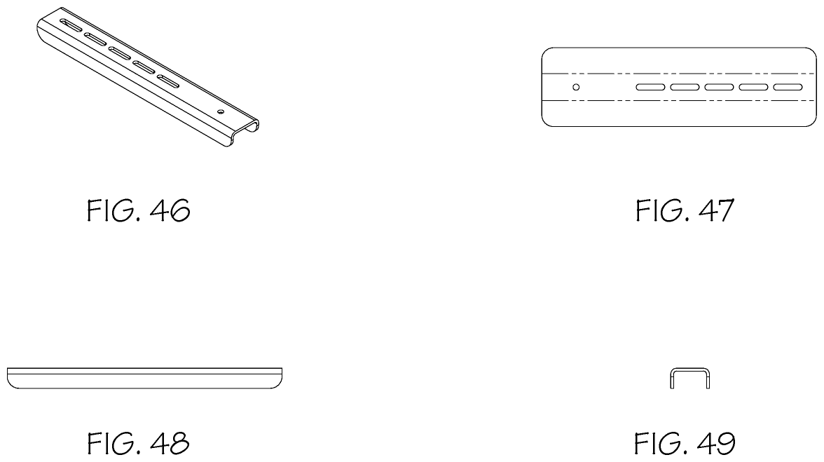

FIG. 46 shows a top perspective view of an embodiment of an inner part of a narrow cross bar.

FIG. 47 shows a bottom view of the inner part.

FIG. 48 shows a side view of the inner part.

FIG. 49 shows an end view of the inner part.

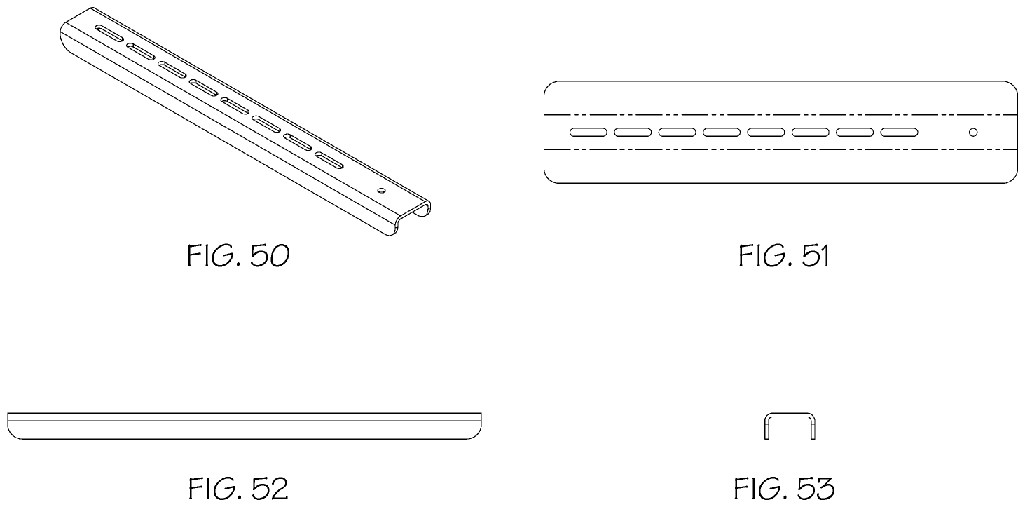

FIG. 50 shows a top perspective view of an alternative embodiment of an inner part of a narrow cross bar.

FIG. 51 shows a bottom view of the inner part.

FIG. 52 shows a side view of the inner part.

FIG. 53 shows an end view of the inner part.

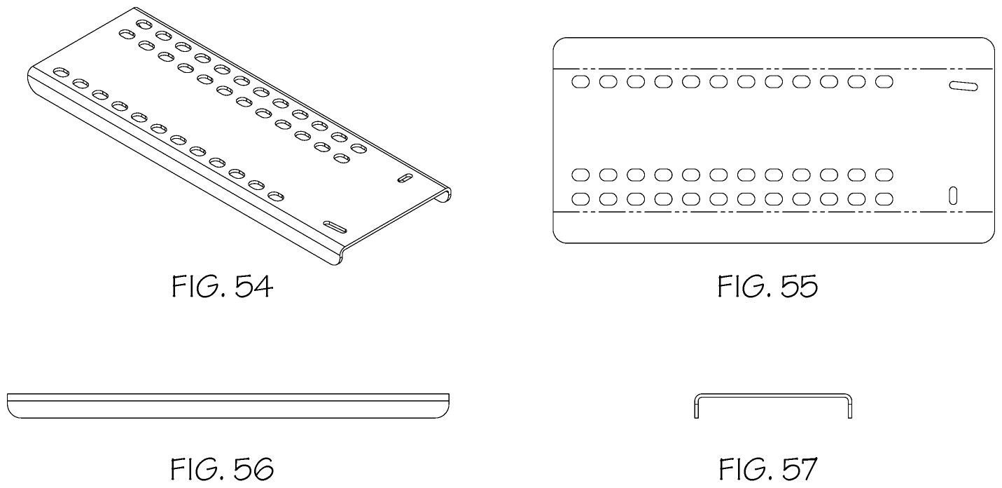

FIG. 54 shows a top perspective view of an inner part of a wide cross bar.

FIG. 55 shows a bottom view of the inner part.

FIG. 56 shows a side view of the inner part.

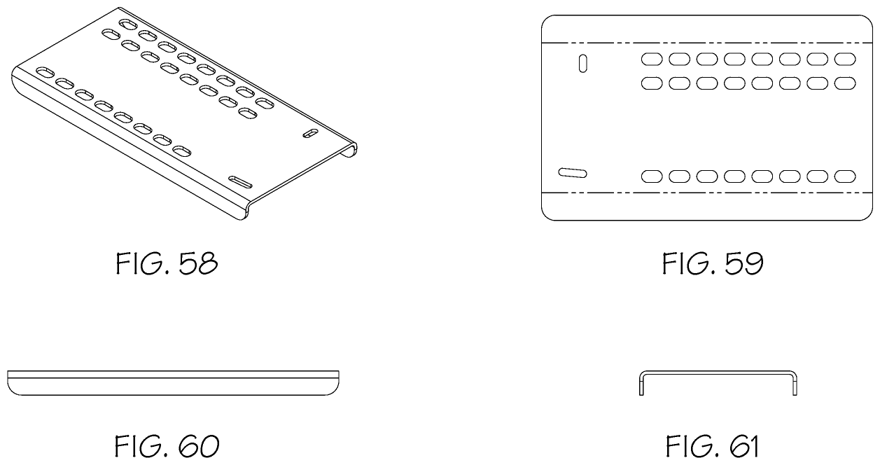

FIG. 57 shows an end view of the inner part.

FIG. 58 shows a top perspective view of an alternative embodiment inner part of a wide cross bar.

FIG. 59 shows a bottom view of the inner part.

FIG. 60 shows a side view of the inner part.

FIG. 61 shows an end view of the inner part.

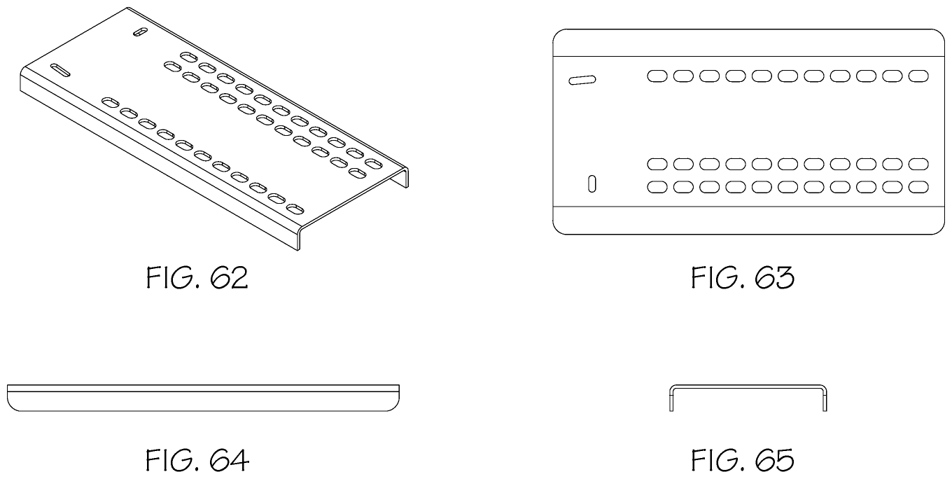

FIG. 62 shows a top perspective view of an alternative embodiment outer part of a wide cross bar.

FIG. 63 shows a bottom view of the outer part.

FIG. 64 shows a side view of the outer part.

FIG. 65 shows an end view of the outer part.

In this embodiment, the side rails 12 and 14 can be assembled parallel to each other or at angles to each other. Each cross bar is comprised of two sections, which slide inside one another to adjust for length. The two sections are of different lengths, for example 12 inches and 16 inches, and the sections can be assembled to make cross bars of different lengths, for example:

a. Two wide cross bars 16 and 18 can be assembled:
i. Long/short sections and short/long sections for parallel side rails or
ii. Long/long sections and short/short sections for angled side rails.

Similarly, the two narrow cross bars 20 and 22 are also made of two sections which slide one inside the other to adjust for length. Two narrow cross bars can be assembled:
i. Long/short sections and short/long sections for parallel side rails or
ii. Long/long sections and short/short sections for angled side rails

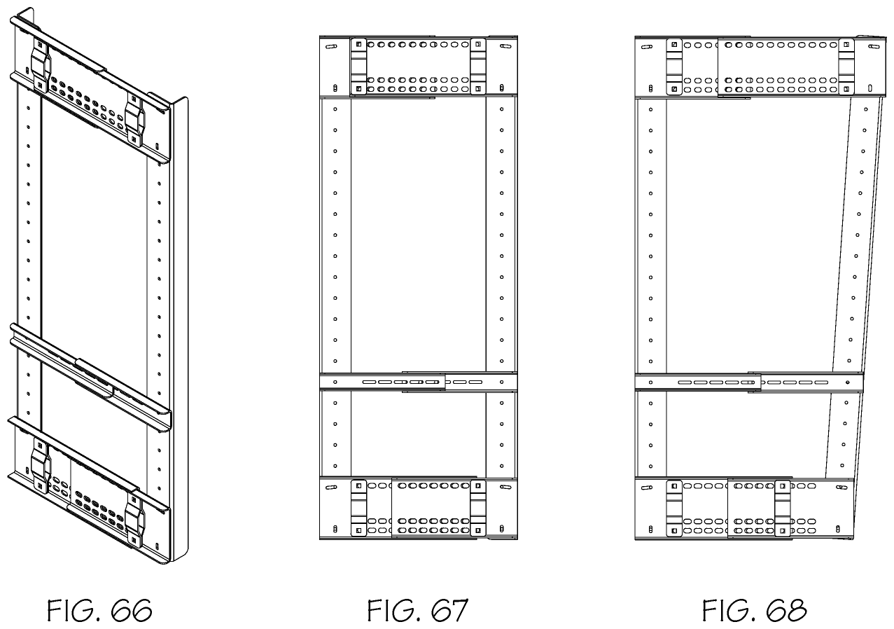

FIG. 66 shows a perspective view of a third embodiment of the invention, an adjustable width ladder rack configured for an extension ladder, a step ladder or a multi-positional ladder.

FIG. 67 shows a view of the ladder rack of FIG. 66 in a first width.

FIG. 68 shows a view of the ladder rack of FIG. 66 in a second wider width.

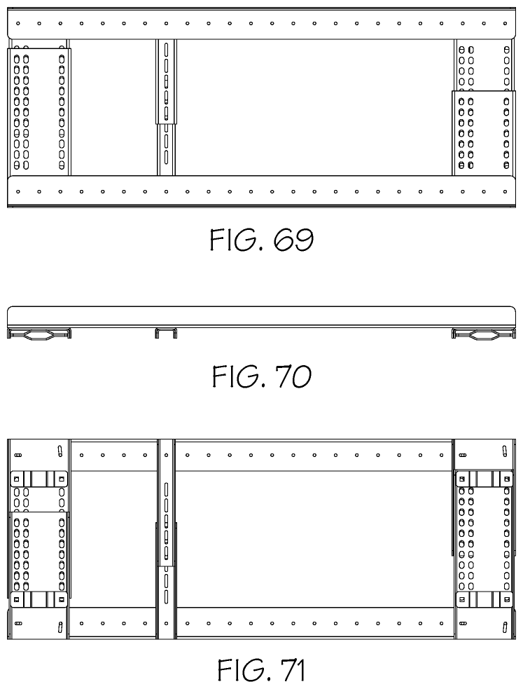

FIG. 69 shows a top view of the ladder rack of FIG. 66.

FIG. 70 shows a side view of the ladder rack of FIG. 66.

FIG. 71 shows a bottom view of the ladder rack of FIG. 2660.

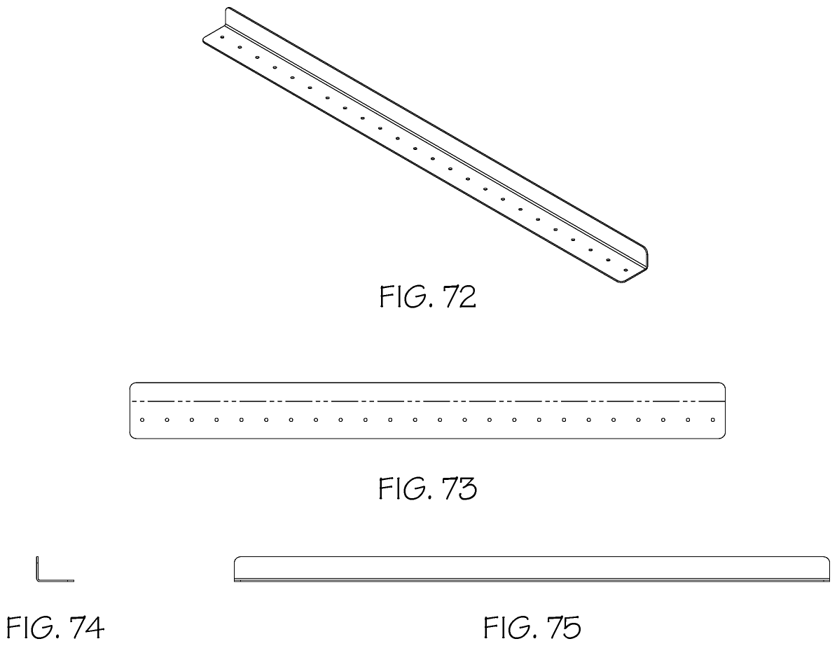

FIG. 72 shows a perspective view of a side rail.

FIG. 73 shows a side view of the side rail.

FIG. 74 shows an end view of the side rail.

FIG. 75 shows a bottom view of the side rail.

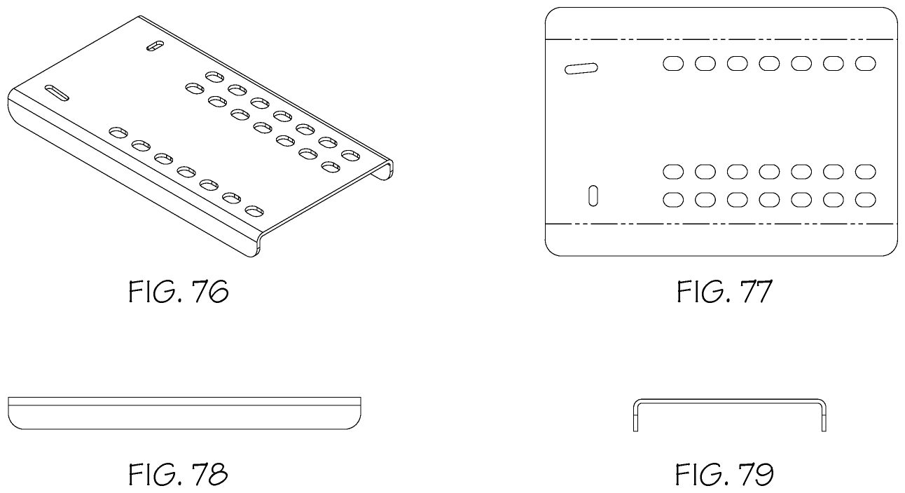

FIG. 76 shows a top perspective view of an outer part of a wide cross bar.

FIG. 77 shows a bottom view of the outer part.

FIG. 78 shows a side view of the outer part.

FIG. 79 shows an end view of the outer part.

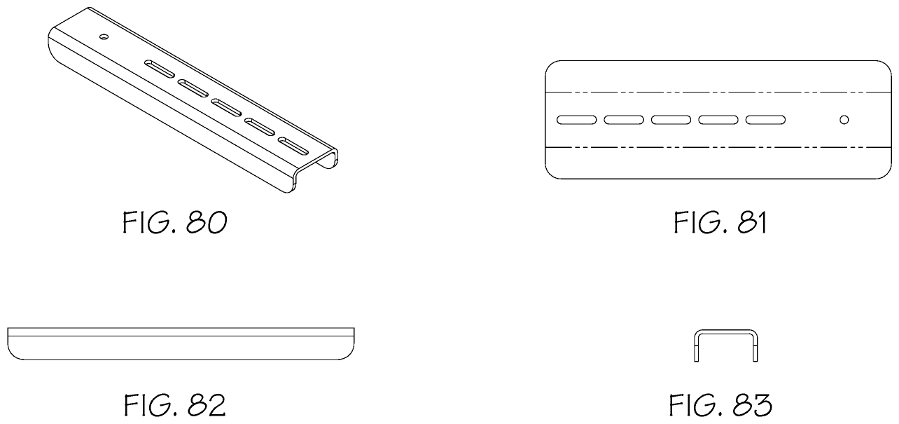

FIG. 80 shows a top perspective view of an outer part of a narrow cross bar.

FIG. 81 shows a bottom view of the outer part.

FIG. 82 shows a side view of the outer part.

FIG. 83 shows an end view of the outer part.

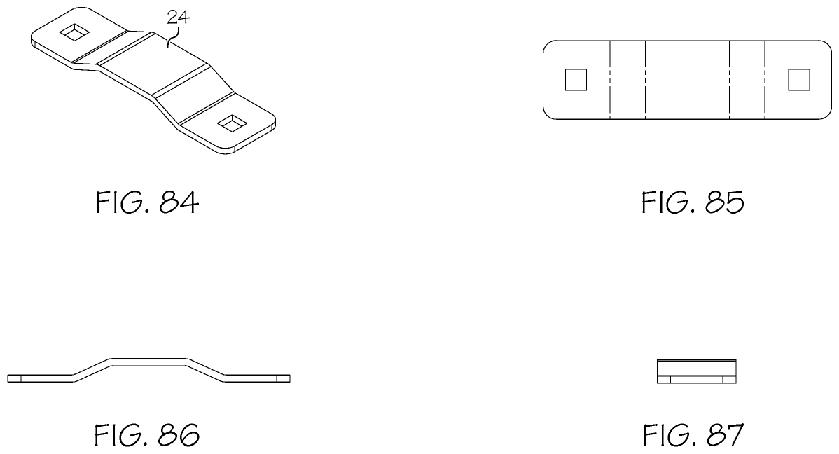

FIG. 84 shows a top perspective view of a mounting bracket.

FIG. 85 shows a bottom view of the mounting bracket.

FIG. 86 shows a side view of the mounting bracket.

FIG. 87 shows an end view of the mounting bracket.

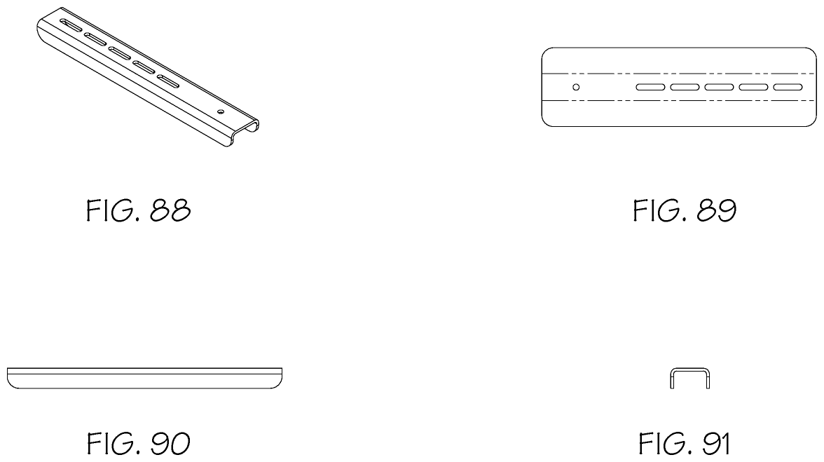

FIG. 88 shows a top perspective view of an alternative embodiment of an inner part of a narrow cross bar.

FIG. 89 shows a bottom view of the inner part.

FIG. 90 shows a side view of the inner part.

FIG. 91 shows an end view of the inner part.

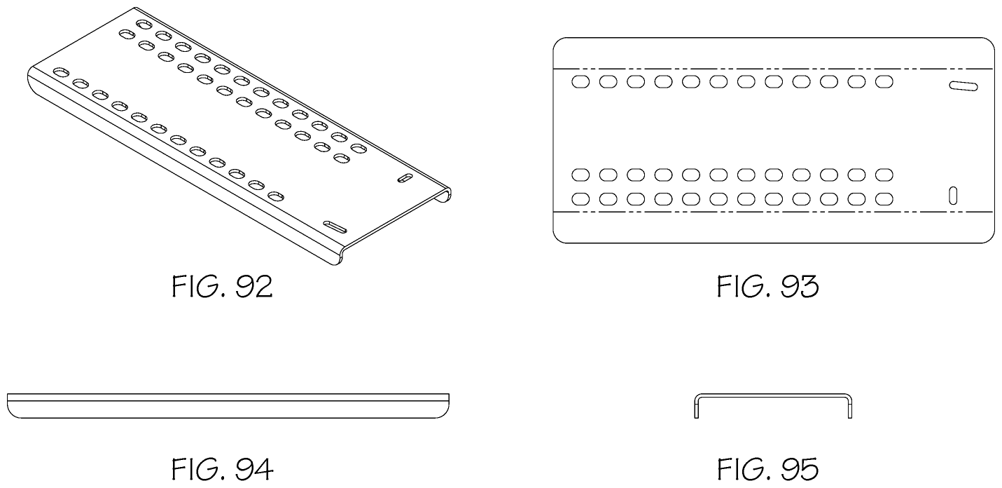

FIG. 92 shows a top perspective view of an embodiment of an inner part of a narrow cross bar.

FIG. 93 shows a bottom view of the inner part.

FIG. 94 shows a side view of the inner part.

FIG. 95 shows an end view of the inner part.

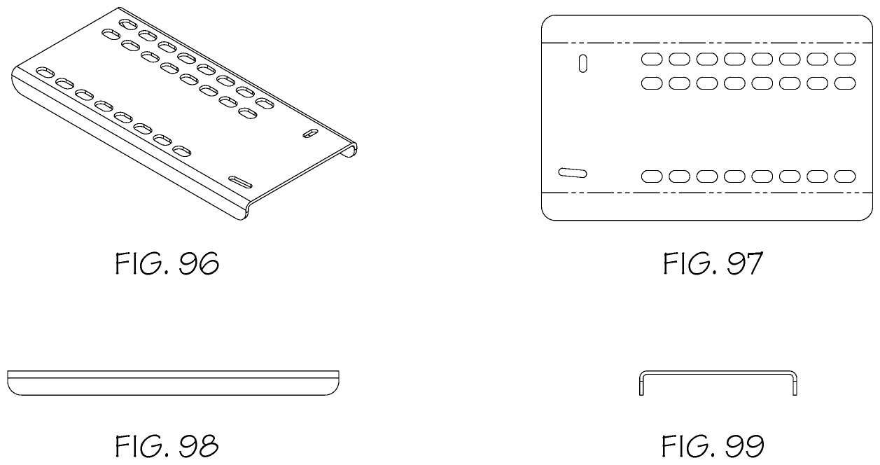

FIG. 96 shows a top perspective view of an alternative embodiment of an inner part of a narrow cross bar.

FIG. 97 shows a bottom view of the inner part.

FIG. 98 shows a side view of the inner part.

FIG. 99 shows an end view of the inner part.

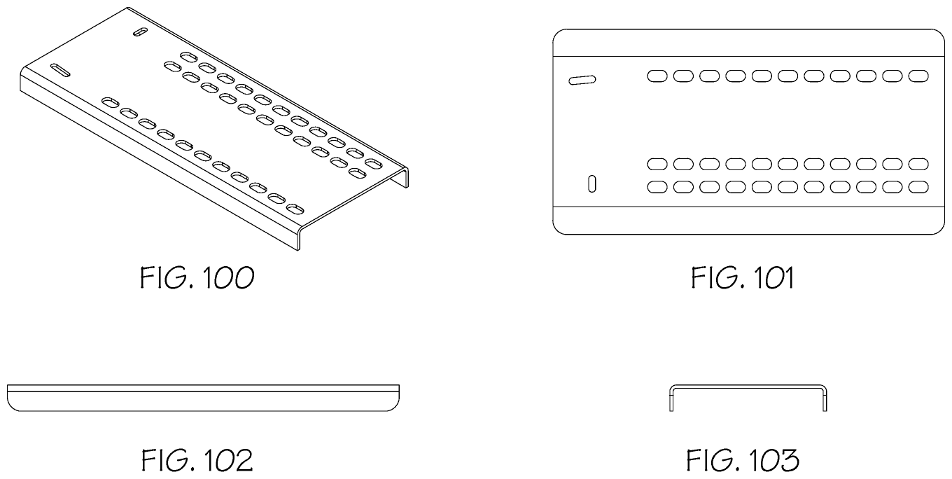

FIG. 100 shows a top perspective view of an outer part of a wide cross bar.

FIG. 101 shows a bottom view of the outer part.

FIG. 102 shows a side view of the outer part.

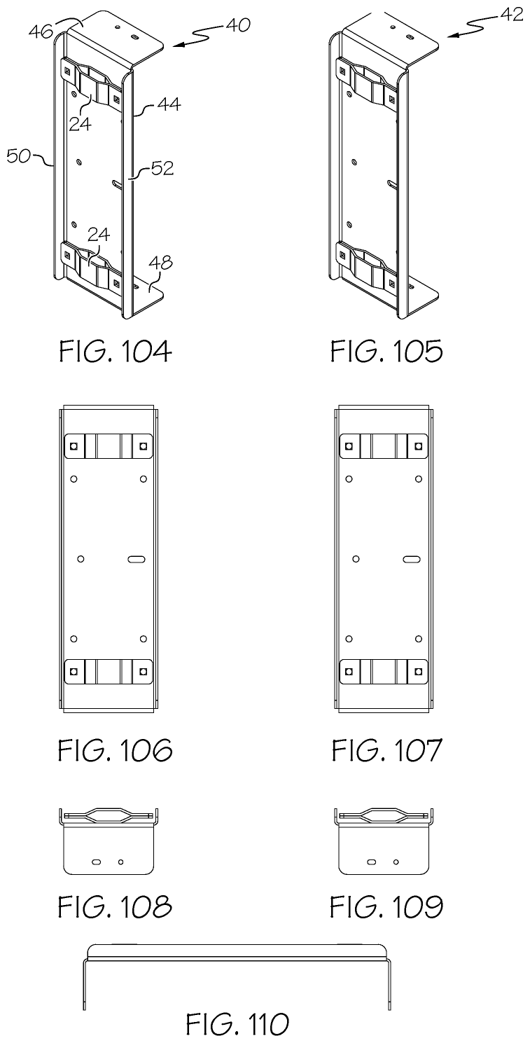

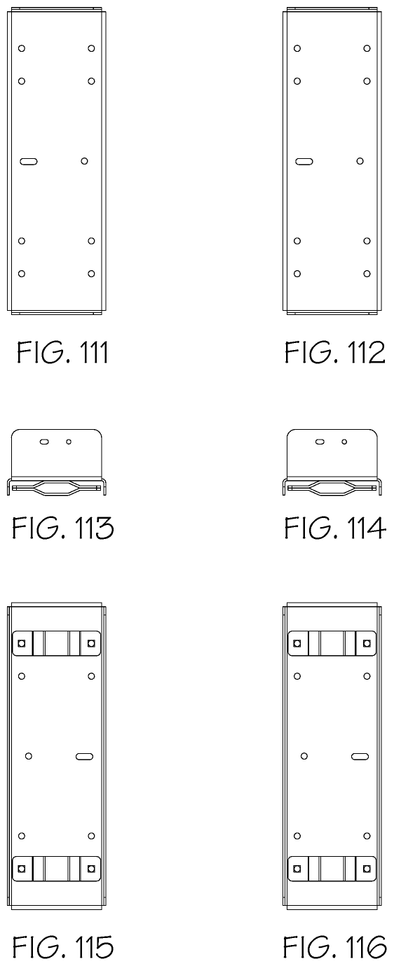

FIG. 103 shows an end view of the outer part.

FIG. 104 shows a bottom perspective view of one of a pair of a fourth embodiment of the invention, a mini ladder rack, shown generally at 40.

FIG. 105 shows the other of the pair, shown generally at 42. Each of the pair of 40 and 42 have a flat top side 44, side flanges 46 and 48, bottom flanges 50 and 52 and two brackets 24.

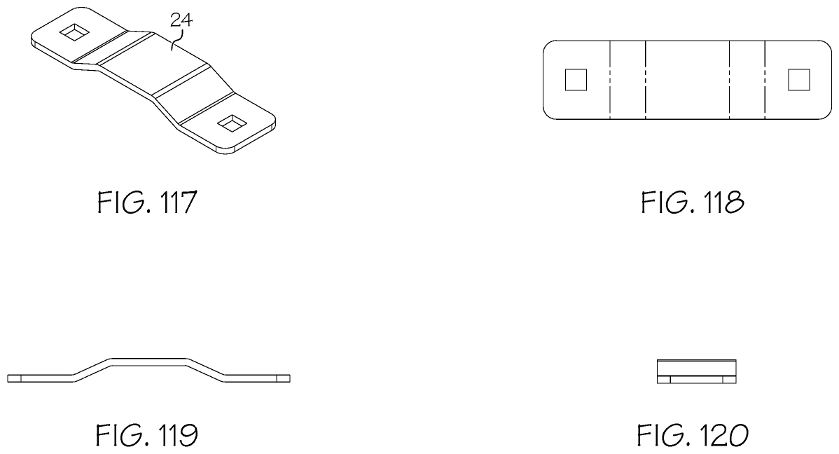

FIG. 106 shows a bottom view of FIG. 104.

FIG. 107 shows the bottom view of FIG. 105.

FIG. 108 shows a side view of FIG. 104.

FIG. 109 shows a side view of FIG. 105.

FIG. 110 shows an end view of the fourth embodiment.

FIG. 111 shows a top view of FIG. 104.

FIG. 112 shows a top view of FIG. 105.

FIG. 113 shows a side view of FIG. 104.

FIG. 114 shows a side view of FIG. 105.

FIG. 115 shows a bottom view of FIG. 104.

FIG. 116 shows a bottom view of FIG. 105.

FIG. 117 shows a top perspective view of a mounting bracket.

FIG. 118 shows a bottom view of the mounting bracket.

FIG. 119 shows a side view of the mounting bracket.

FIG. 120 shows an end view of the mounting bracket.

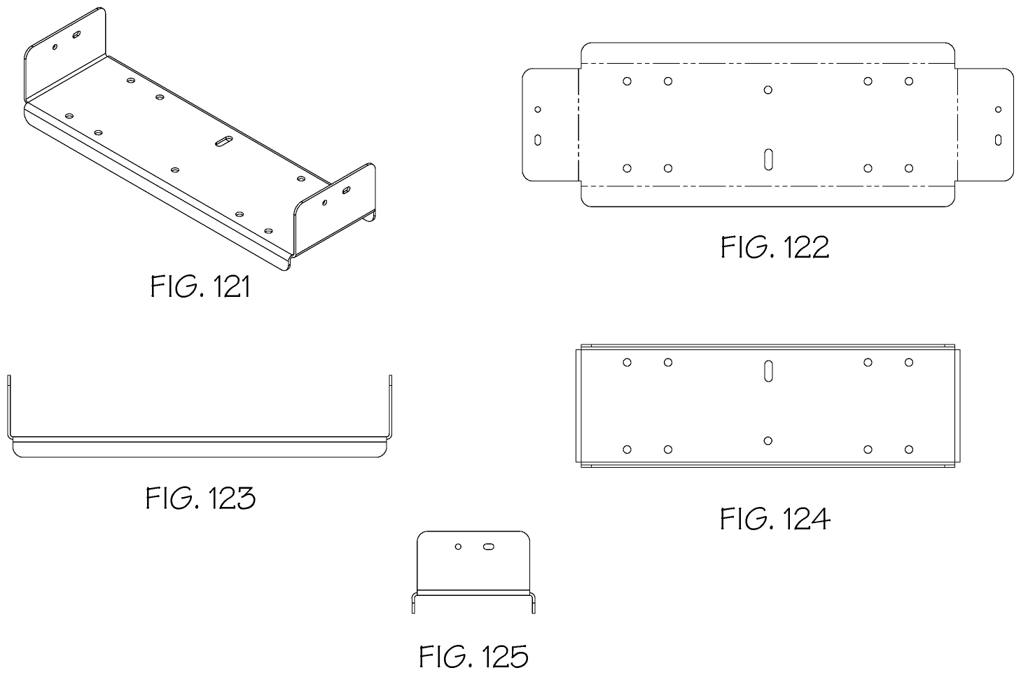

FIG. 121 shows a top perspective view of one of the pair of the fourth embodiment.

FIG. 122 shows FIG. 121 before the sides are bent up and the channel flanges are bent down.

FIG. 123 shows a side view of FIG. 121.

FIG. 124 shows a bottom view of FIG. 121.

FIG. 125 shows an end view of FIG. 121.

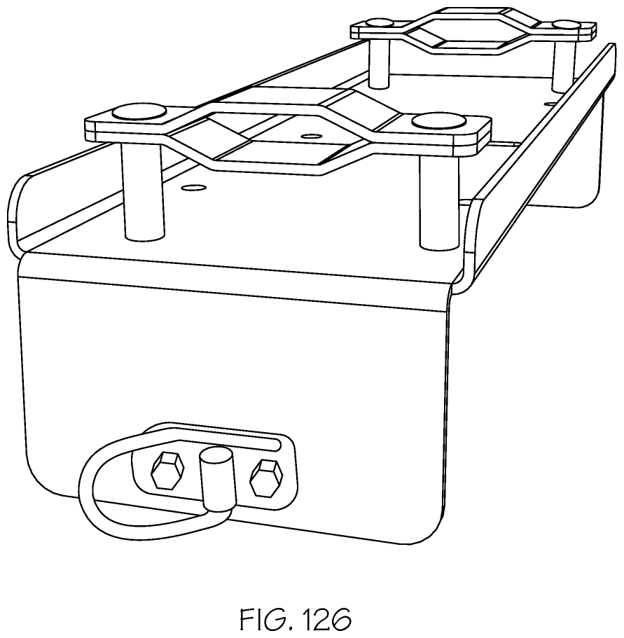

FIG. 126 shows the bottom and side of the fourth embodiment prior to being attached to a vehicle.

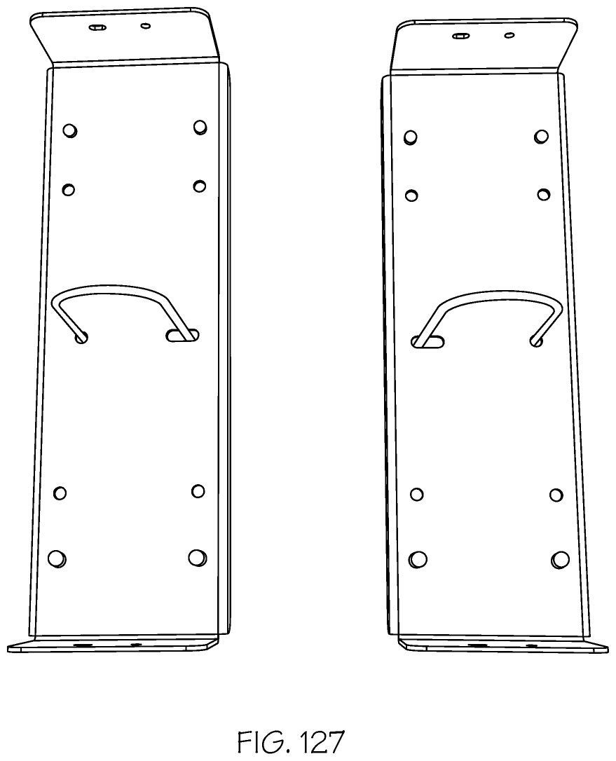

FIG. 127 shows the top of a pair of the fourth embodiment, with the U bolt attached.

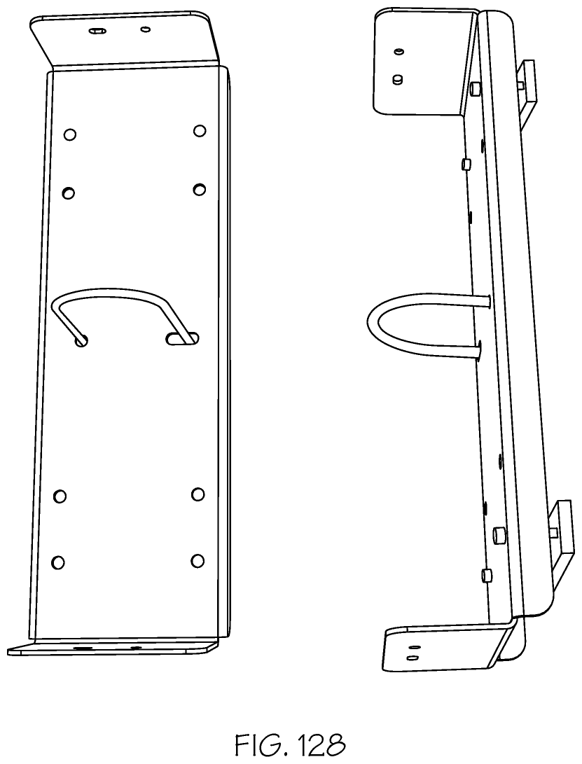

FIG. 128 shows a top view of one of the pair of the fourth embodiment, and a side view of the other of the pair.

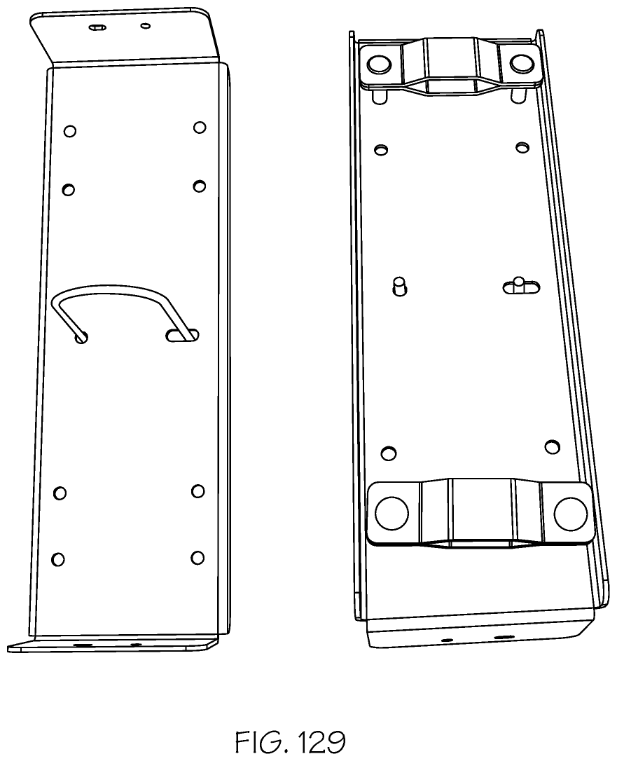

FIG. 129 shows a top view of one of the pair of the fourth embodiment, and a bottom view of the other of the pair.

The ladder rack of the fourth embodiment is designed to be mounted to a vehicle with a manufacturer roof rack with cross bars or an after-market roof rack with cross bars. This ladder rack is designed to carry extension ladders and each of the wide cross bars have custom bent tabs on ends of the wide cross bars to prevent lateral movement of ladder, pre-cut holes for attachment of ‘U’-bolts, pre-cut holes for attachment of mounting brackets to bottom of cross bars and pre-cut holes on end tabs of cross bars for attachment of ‘D’ rings. Four ‘D’-rings are attached one each to each end tab of the wide cross bars to attach tie-down straps. Two ‘U’-bolts are attached one each to the top of the wide cross bars to attach tie-downs and control forward and backward movement of ladder on ladder rack.

Four mounting brackets are attached two each to the bottom of wide cross bars to attach the ladder rack to manufacturer or after-market roof rack on vehicle. The mounting brackets are made of four pairs of brackets of arched stainless steel with pre-cut square holes on the ends of brackets to receive the square shank of carriage bolt for assembly. Nylon spacers allow adjustment of the brackets to accommodate vehicle roof racks with cross bars of varying sizes. Four pairs of carriage bolts with lock nuts are required to attach the mounting brackets to the ladder rack.

The ladder cross bars and mounting brackets are custom laser cut with radius corners and bends for appearance, strength and safety. The mini fixed width ladder rack does not have connecting side rails attached between the wide cross bars.

FIG. 130 shows a bottom perspective view of one of a pair of a fifth embodiment of the invention, an adjustable mini ladder rack.

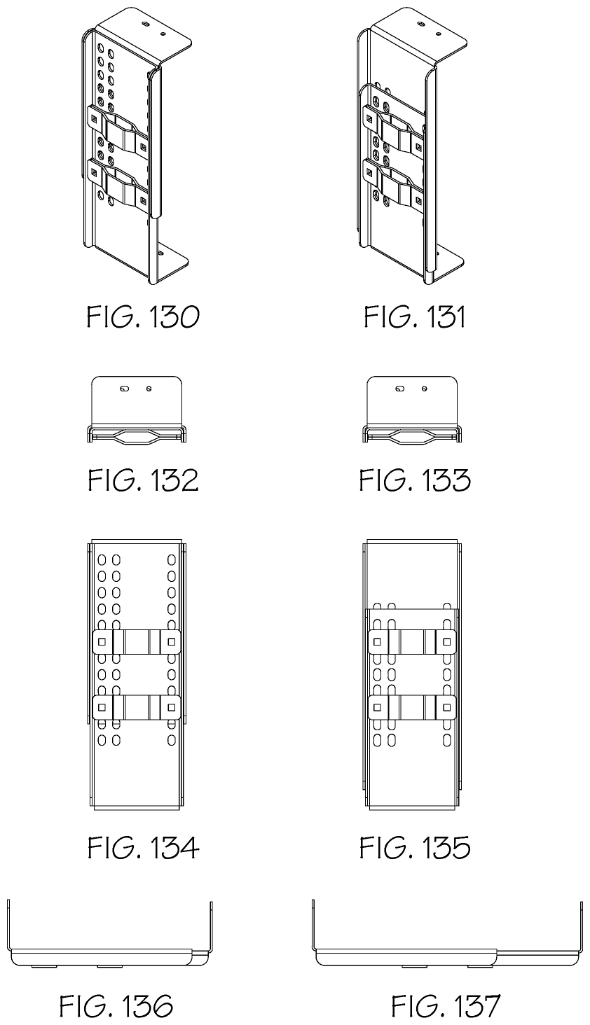

FIG. 131 shows the other of the pair.

FIG. 132 shows an side view of FIG. 130.

FIG. 133 shows a side view of FIG. 131.

FIG. 134 shows a bottom view of FIG. 130.

FIG. 135 shows the bottom view of FIG. 131.

FIG. 136 shows a front view of the fifth embodiment in a first width.

FIG. 137 shows a front view of the fifth embodiment in a second wider width.

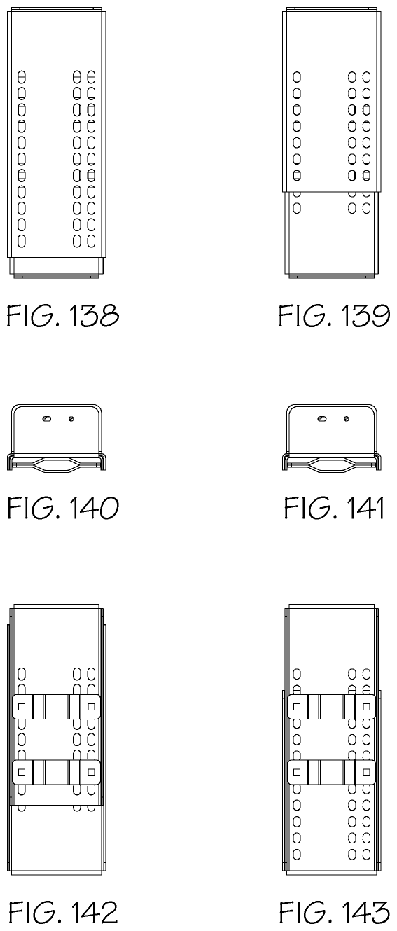

FIG. 138 shows a top view at the first width.

FIG. 139 shows a top view at the wider width.

FIG. 140 shows a side view of FIG. 130.

FIG. 141 shows a side view of FIG. 131.

FIG. 142 shows a bottom view of FIG. 130.

FIG. 143 shows a bottom view of FIG. 131.

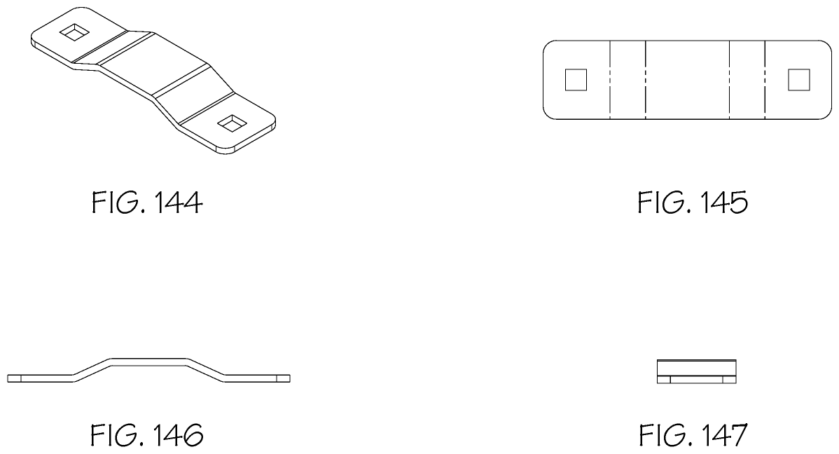

FIG. 144 shows a top perspective view of a mounting bracket.

FIG. 145 shows a bottom view of the mounting bracket.

FIG. 146 shows a side view of the mounting bracket.

FIG. 147 shows an end view of the mounting bracket.

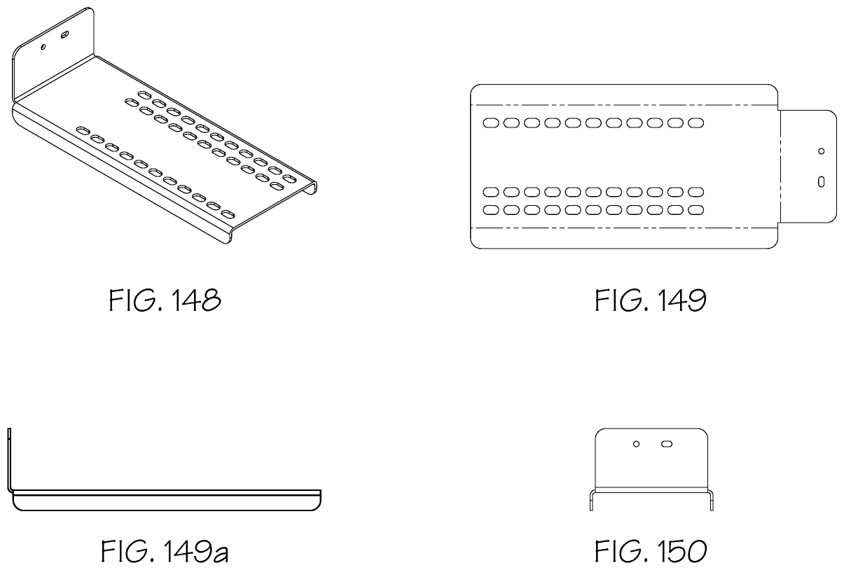

FIG. 148 shows a top perspective view of an outer part of the pair of the fifth embodiment.

FIG. 149 shows FIG. 148 before the side is bent up and the channel flanges are bent down.

FIG. 149a shows a side view of FIG. 148.

FIG. 150 shows an end view of FIG. 148.

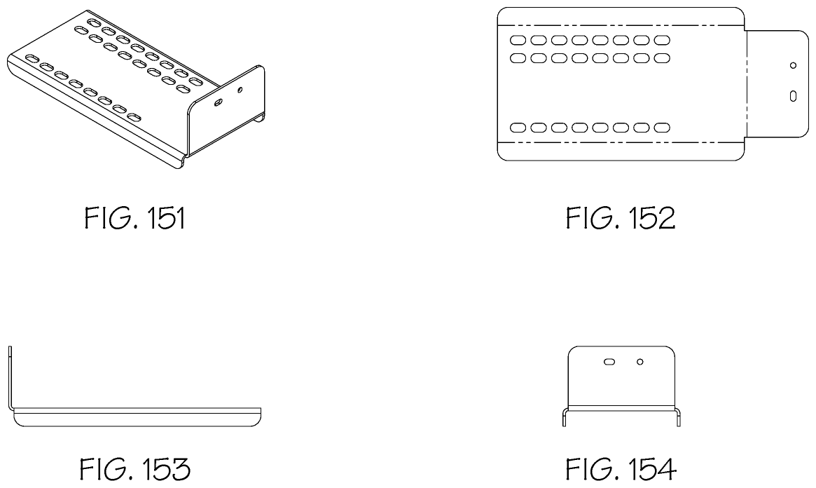

FIG. 151 shows a top perspective view of an inner part of the pair of the fifth embodiment.

FIG. 152 shows FIG. 151 before the side is bent up and the channel flanges are bent down.

FIG. 153 shows a side view of FIG. 151.

FIG. 154 shows an end view of FIG. 151.

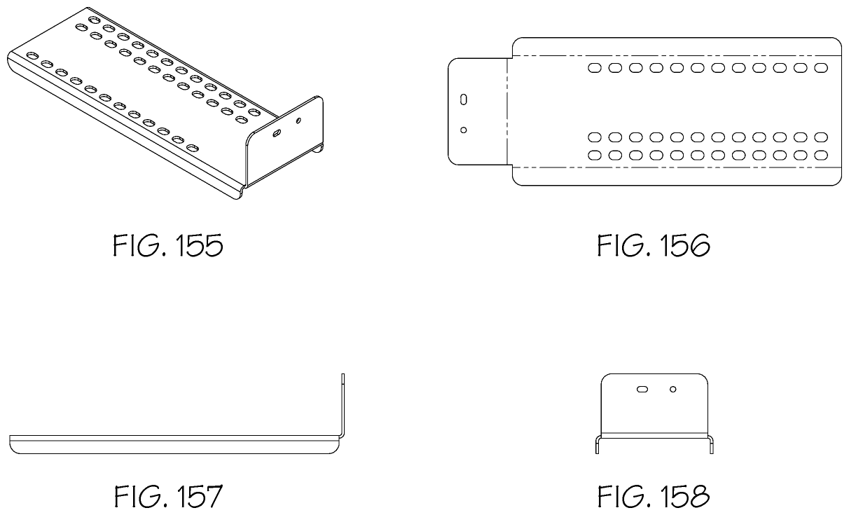

FIG. 155 shows a top perspective view of an alternative inner part of the pair of the fifth embodiment.

FIG. 156 shows FIG. 155 before the side is bent up and the channel flanges are bent down.

FIG. 157 shows a side view of FIG. 155.

FIG. 158 shows an end view of FIG. 155.

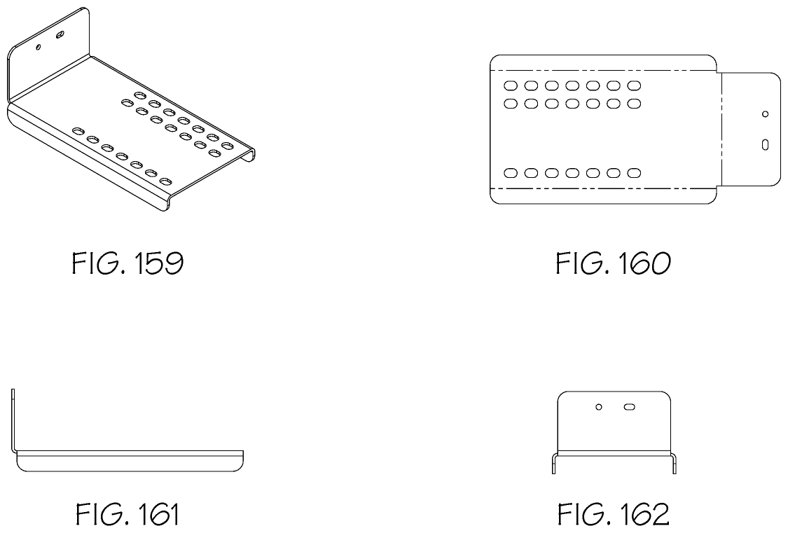

FIG. 159 shows a top perspective view of an alternative outer part of the pair of the fifth embodiment.

FIG. 160 shows FIG. 159 before the side is bent up and the channel flanges are bent down.

FIG. 161 shows a side view of FIG. 159.

FIG. 162 shows an end view of FIG. 159.

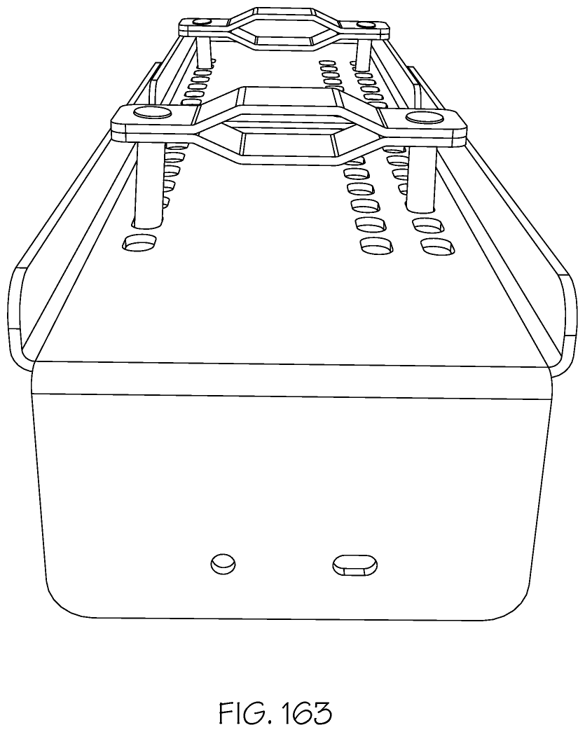

FIG. 163 shows the bottom of the fifth embodiment prior to being attached to a vehicle.

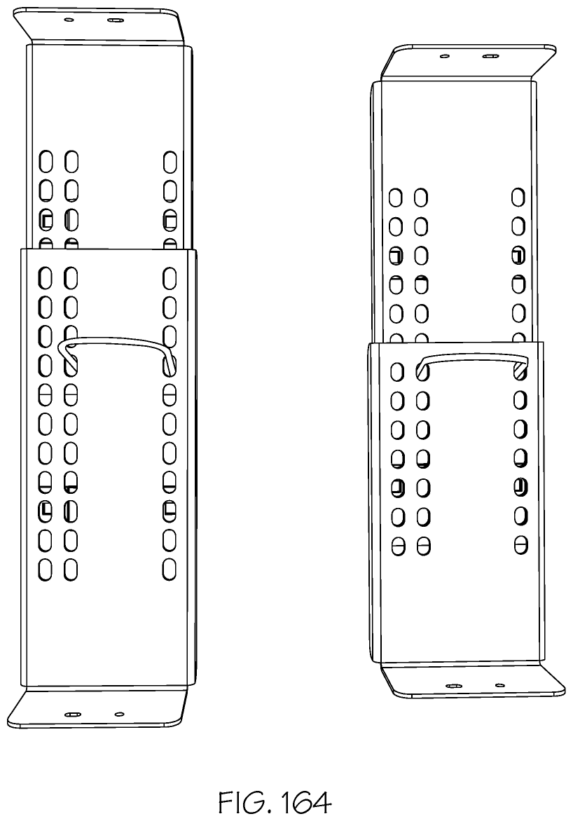

FIG. 164 shows the top of a pair of the fifth embodiment, with the U bolt attached.

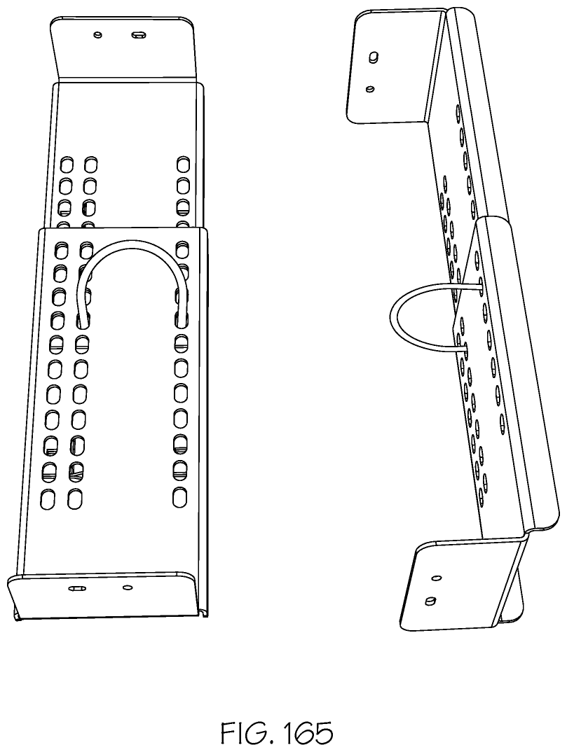

FIG. 165 shows a top view of one of the pair of the fifth embodiment, and a side view of the other of the pair.

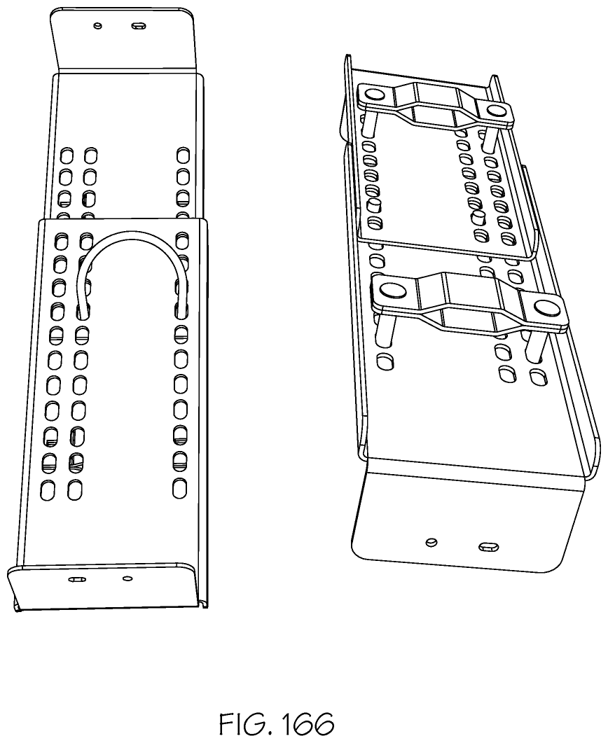

FIG. 166 shows a top view of one of the pair of the fifth embodiment, and a bottom view of the other of the pair.

The fifth embodiment is a mini adjustable width ladder rack. The ladder rack is designed to be mounted to a vehicle with a manufacturer roof rack with cross bars or an after-market roof rack with cross bars. The adjustable width ladder rack is designed to carry extension ladders, step ladders or multi-positional ladders. This embodiment is comprised of two wide cross bars, one at each end of the ladder rack, each cross bar having two sections which slide one inside the other to adjust for length. Right and left sections of cross bars are different lengths which can be assembled in different configurations to achieve cross bars of different lengths. The different lengths can be assembled:
Long/short sections and short/long sections of cross bars for alignment of cross bars with equal lengths to accommodate extension ladders or
Long/long sections and short/short sections of cross bars with different lengths to accommodate step ladders or multi-positional ladders.

The custom bent tabs on ends of each segment of wide cross bars to prevent lateral movement of ladder and pre-cut holes of alternating round and oblong along sides of wide cross bars allows for:

Attachment of ‘U’-bolts

‘U’-bolts also secure right and left sections of wide cross bar together

Pre-cut holes for attachment of mounting brackets to bottom of cross bars.

Four ‘D’-rings attached one each to end tabs of wide cross bars to attach tie-down straps. Two ‘U’-bolts attached one each to top of wide cross bars to attach tie-downs and control forward and backward movement of ladder on ladder rack. Four mounting brackets attached two each to bottom of wide cross bars to attach ladder rack to manufacturer or after-market roof rack on vehicle.

Four mounting brackets are attached two each to the bottom of wide cross bars to attach the ladder rack to manufacturer or after-market roof rack on vehicle. The mounting brackets are made of four pairs of brackets of arched stainless steel with pre-cut square holes on the ends of brackets to receive the square shank of carriage bolt for assembly. Nylon spacers allow adjustment of the brackets to accommodate vehicle roof racks with cross bars of varying sizes. Four pairs of carriage bolts with lock nuts are required to attach the mounting brackets to the ladder rack.

Ladder rack cross bars and mounting brackets are custom laser cut with radius corners and bends for appearance, strength and safety. Cross bars can be assembled in different configurations to fit different style and size vehicles with factory or after-market roof racks. Mini adjustable width ladder rack does not have connecting side rails attached between the wide cross bars

The above disclosure is intended to be illustrative and not exhaustive. This description will suggest many variations and alternatives to one of ordinary skill in this field of art. All these alternatives and variations are intended to be included within the scope of the claims where the term “comprising” means “including, but not limited to.” Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

What is claimed is:

1. A ladder rack comprising:
a pair of side rails each having first and second ends, the pair of side rails connected by at least two cross bars;
a pair of mounting brackets connected to the at least two cross bars, to attach the ladder rack to a roof rack, and
a pair of ladder attachment devices attached to the at least two cross bars for attaching one or more ladders to the ladder rack.

2. The ladder rack of claim 1 wherein the at least two cross bars are each of a fixed length so the side rails are parallel to each other.

3. The ladder rack of claim 1 wherein the at least two cross bars are each comprised of two overlapping cross bar members which can be adjusted so the at least two cross bars are the same length and the side rails are parallel or can be adjusted so some of the at least four cross bars are longer than the others, so the side rails are angled with respect to each other.

4. The ladder rack of claim 3 wherein the two overlapping cross bar members are each 12 inches long.

5. The ladder rack of claim 3 wherein the two overlapping cross bar members are each 18 inches long.

6. The ladder rack of claim 3 wherein the two overlapping cross bar members are one 12 inch and one 18 inch long.

7. The ladder rack of claim 1 wherein the at least two cross bars are four cross bars, and two of the four cross bars are wider than the other two.

8. The ladder rack of claim 1 further wherein the side bars contain a plurality of holes spaced along their length which allow for re-positioning the at least two cross bars to accommodate roof manufacturer racks of varying sizes.

9. The ladder rack of claim 1 wherein the ladder attachment devices are “D” rings and “U” bolts.

10. The ladder rack of claim 1 wherein the ladder rack is sized so two ladder racks can fit side by side on the roof rack.

11. A mini ladder rack comprising:
a pair of mounting brackets connected to each of a pair of cross bars, to attach the ladder rack to a roof rack, and
a pair of ladder attachment devices attached to each of the cross bars for attaching one or more ladders to the ladder rack.

12. The mini ladder rack of claim 11 wherein the pair of cross bars are each of a fixed length.

13. The mini ladder rack of claim 11 wherein the pair of cross bars are each comprised of two overlapping cross bar members which can be adjusted so the each cross bar can have a variable length.

14. The mini ladder rack of claim 13 wherein the two overlapping cross bar members can range in length from 16.50 inches to 22.50 inches.

15. The mini ladder rack of claim 13 wherein the two overlapping cross bar members each have a slightly different width, so that one can slide inside the other.

16. The mini ladder rack of claim 15 wherein one of the two overlapping cross bar members has a width of 6 inches and the other one of the two overlapping cross bar members has a width of 5.69 inches.

17. The mini ladder rack of claim 11 wherein the ladder attachment devices are “D” rings.

18. The mini ladder rack of claim 11 wherein the ladder rack is sized so two ladder racks can fit side by side on the roof rack.

19. The mini ladder rack of claim 11 wherein each cross bar includes tabs which hold a ladder on the mini ladder rack and prevent lateral movement of the ladder.

20. The mini ladder rack of claim 13 further including a U-bolt which attaches to each cross bar and can be used to prevent forward and rearward movement of a ladder.

21. The mini ladder rack of claim 20 further including a U-bolt which attaches the two overlapping cross bar members to each other and can also be used to prevent forward and rearward movement of a ladder.

22. The mini ladder rack of claim 14 wherein each of the four overlapping cross bar members making up the pair of cross bars has a different length.

23. The mini ladder rack of claim 22 wherein the different lengths are 11.26 inches, 12.26 inches, 15.26 inches and 16.26 inches.

24. The mini ladder rack of claim 14 wherein when the cross bar is adjusted to be of length 16.50 inches, that at least one mounting bracket of the pair of mounting brackets connects the two overlapping cross bar members to each other.

25. The mini ladder rack of claim 23 wherein one of the two overlapping cross bar members making up a rear crossbar can be interchanged with one of the two overlapping cross bar members making up a front crossbar.
